(19) United States
(12) Patent Application Publication
(10) Pub. No.: US 2007/0006954 A1
(43) Pub. Date: Jan. 11, 2007

(54) Pneumatic tire and mold for the tire

(75) Inventors: Fumihiro Tsubono, Kobe-shi (JP); Takamichi Sagawa, Kobe-shi (JP)

Correspondence Address: BIRCH STEWART KOLASCH & BIRCH, PO BOX 747, FALLS CHURCH, VA, 22040-0747, US

(73) Assignee: Sumitomo Rubber Industries, Ltd.

(21) Appl. No.: 11/475,897

(22) Filed: Jun. 28, 2006

(30) Foreign Application Priority Data
Jul. 8, 2005 (JP) 2005-200694

(51) Int. Cl. B60C 11/13

(52) U.S. Cl. 152/209.23; 152/209.4; 152/209.25; 425/28.1

(57) ABSTRACT

A cavity face 34 of a mold 32 has a protruding ridge P. A shape of cross section of the ridge P is almost rectangular. The ridge P has a first corner P1, a second corner P2, a third corner P3 and a fourth corner P4. The ridge P has a height H of 0.1 mm or greater and 1.0 mm or less. The ridge P has a width W2 of 0.1 mm or greater and 2.0 mm or less. A curvature radius Rc of the second corner P2 and a curvature radius Rd of the third corner P3 are equal to or less than 0.2 mm. Included angles β1, β2, β3 and β4 of the ridge P are 80° or greater and 100° or less. A tire which is obtained by the mold 32 has small grooves with a reversed shape of the ridge P.

This application claims priority on Japanese Patent Application No. 2005-200694 filed on Jul. 8, 2005, the entire contents of which are hereby incorporated by reference.

### BACKGROUND OF THE INVENTION

1. Field of the Invention

The present invention relates to a pneumatic tire. More particularly, the present invention relates to an improvement of a tread of a tire.

2. Description of the Related Art

On snowy and icy road surfaces, a spike tire has been used for a long time. In recent years, a studless tire is a mainstream. In the studless tire, a braking performance on the snowy and icy road surfaces is important. In order to enhance the braking performance, a tire obtained by blending a glass fiber with a tread has been put on the market. The glass fiber has a higher hardness than ice. In the tire obtained by blending the glass fiber with the tread, the glass fiber scratches the snowy and icy road surfaces. By the scratch, the braking performance of the tire can be enhanced.

In the vulcanization of the tire, the tread abuts on the cavity surface of a mold. By the abutment, a skin layer is formed on the tread. The surface of the skin layer has a mirror finished surface. A short fiber is not exposed on the surface of the skin layer. When the tire is used, the skin layer is worn out at a comparatively early stage. By the wear-out, the glass fiber is exposed on the surface of the tread. By the exposure, the braking performance can be exhibited.

There have been made various proposals intended for enhancing the braking performance in a state in which the skin layer remains. For example, Japanese Laid-Open Patent Publication No. Hei 9-323511 has disclosed a tire comprising a siping (i.e. a small groove) having a small depth on the tread thereof. The tire is formed by a mold having fine ridges on a cavity face. The small groove has a reversed shape of the ridge.

In a molding of a tire, a preformed green tire is put in a mold and the green tire is compressed and heated. By the heating, a rubber is crosslinked. When the mold is repeatedly used, the rubber or chemicals in the rubber composition adhere to a cavity face and accumulate. The amount of the sediment increases gradually. As the sediment increases, troubles with demolding, appearance of a tire, an air vent and the like are caused. The sediment needs to be removed.

To remove the sediment, a shot blasting treatment is generally used. By the shot blasting treatment, a surface of the mold is ground. As the ground amount is small, grinding is not a big problem for a common mold. However, in a mold having fine ridges, the ridges are gradually worn out by repetitive grinding. In particular, when the ridge has a cross section of a tapered shape such as semicircle, triangle, trapezium and the like, the ridge is deformed to a large extent by the shot blasting treatment. When a mold with ridges having an inappropriate shape is used, a tire with small grooves having an inappropriate shape is obtained. This tire is insufficient in a braking performance at the start of use.

An object of the present invention is to provide molds which can mold tires with favorable small grooves over a long period. Another object of the present invention is to provide pneumatic tires which are excellent in a braking performance at the start of use.

### SUMMARY OF THE INVENTION

A pneumatic tire according to the present invention has a tread portion. A large number of small grooves with a width of 0.1 mm or greater and 2.0 mm or less and a depth of 0.1 mm or greater and 1.0 mm or less are formed on the surface of the tread portion. The shape of cross section of the small groove is almost rectangular.

Preferably, curvature radius of the corner at the bottom of the small groove is equal to or less than 0.2 mm. Preferably, the tread portion is formed by crosslinking a rubber composition having a short fiber dispersed therein. Preferably, the tread portion has a vertical groove, a lateral groove and a large number of blocks partitioned by the vertical groove and the lateral groove. On the surface of the blocks, the small grooves are formed.

A mold for a tire according to the present invention has a cavity face which abuts on a tread portion of a tire. A large number of ridges with a width of 0.1 mm or greater and 2.0 mm or less and a height of 0.1 mm or greater and 1.0 mm or less are formed on the cavity face. The shape of cross section of the ridge is almost rectangular. Preferably, curvature radius of the corner of top surface of the ridge is equal to or less than 0.2 mm.

In the mold according to the present invention, an appropriate shape of the ridge is maintained when the mold is repeatedly used. A tire obtained by the mold is excellent in a braking performance at the start of use.

### BRIEF DESCRIPTION OF THE DRAWINGS

FIG. 1 is a sectional view showing a pneumatic tire according to an embodiment of the present invention,

FIG. 2 is an enlarged view showing a part of a tread portion of the tire in FIG. 1,

FIG. 3 is a sectional view showing a part of the tread portion of the tire in FIG. 1,

FIG. 4 is a sectional view showing a part of a mold used at a step of vulcanization of the tire in FIG. 1,

FIG. 5 (a) is a sectional view showing a part of a mold related to Comparative Example 1,

FIG. 5 (b) is a sectional view showing a part of a mold related to Comparative Example 2, and

FIG. 5 (c) is a sectional view showing a part of a mold related to Comparative Example 3.

### DESCRIPTION OF THE PREFERRED EMBODIMENTS

The present invention will be described below in detail based on preferred embodiments with reference to the drawings.

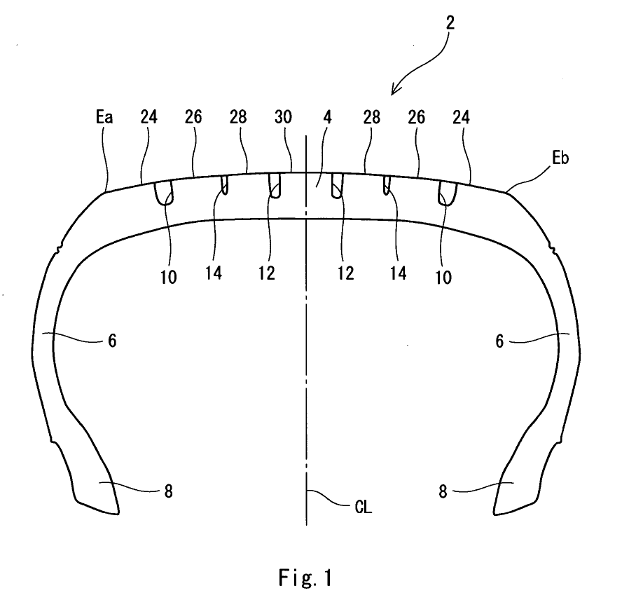

In FIG. 1, a vertical direction is set to be a radial direction of a pneumatic tire 2 and a transverse direction is set to be an axial direction of the tire 2. The tire 2 comprises a tread portion 4, left and right sidewall portions 6, and left and right bead portions 8. In the tire 2, a carcass is laid between the bead portion 8 on the left side and the bead portion 8 on the right side, which is not shown.

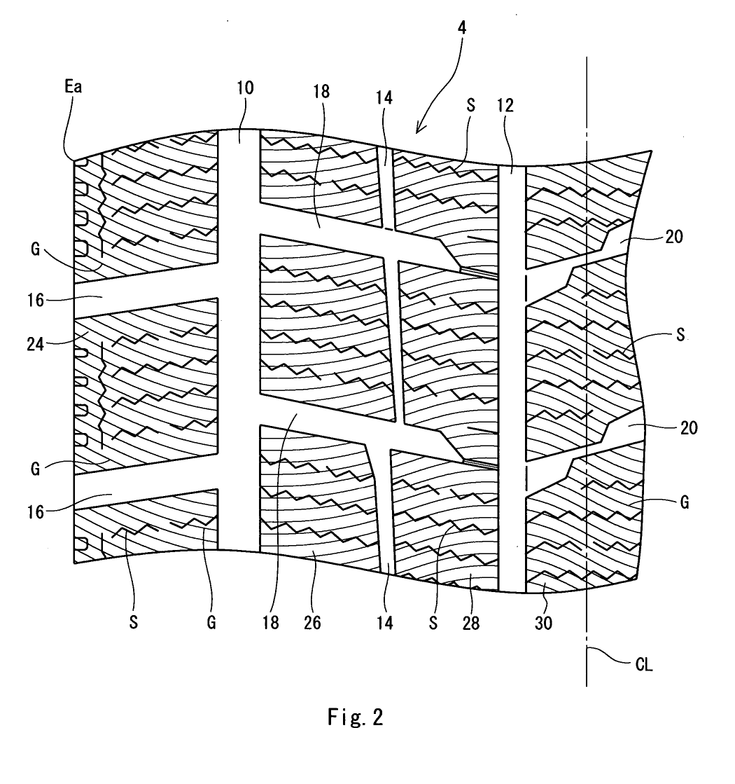

FIG. 2 is an enlarged development view showing a part of the tread portion 4 of the tire 2 in FIG. 1. In FIG. 2, a vertical direction is set to be a circumferential direction of the tire 2 and a transverse direction is set to be an axial direction of the tire 2. A center line CL shown in FIG. 2 indicates an equator plane of the tire 2. The tire 2 is a studless tire.

The tread portion 4 includes a first vertical groove 10, a second vertical groove 12, a subvertical groove 14, a first lateral groove 16, a second lateral groove 18, and a third lateral groove 20 on the surface thereof. The first vertical groove 10 and the second vertical groove 12 are extended wholly in the circumferential direction. The first lateral groove 16 couples a tread end Ea to the first vertical groove 10. The second lateral groove 18 couples the first vertical groove 10 to the second vertical groove 12. The third lateral groove 20 couples the second vertical groove 12 on the right side (see FIG. 1) to the second vertical groove 12 on the left side. The subvertical groove 14 is present between the two second lateral grooves 18.

The tread portion 4 includes a first block 24, a second block 26, a third block 28 and a fourth block 30. The contour of each of the blocks 24, 26, 28 and 30 substantially takes a square shape. A block taking another contour shape may be provided. The first block 24 is positioned on the outside of the first vertical groove 10. The first block 24 is partitioned by the first vertical groove 10 and the two first lateral grooves 16. The second block 26 is positioned between the first vertical groove 10 and the subvertical groove 14. The second block 26 is partitioned by the first vertical groove 10, the subvertical groove 14 and the two second lateral grooves 18. The third block 28 is positioned between the subvertical groove 14 and the second vertical groove 12. The third block 28 is partitioned by the subvertical groove 14, the second vertical groove 12 and the two second lateral grooves 18. The fourth block 30 is provided across the equator plane CL. The fourth block 30 is positioned between the second vertical groove 12 on the right side and the second vertical groove 12 on the left side. The fourth block 30 is partitioned by the two second vertical grooves 12 and the two third lateral grooves 20.

Each of the blocks 24, 26, 28 and 30 has a siping S. The siping S has a zigzag shape. The siping S is formed by a knife blade of a mold. By the edge effect and dewatering function of the siping S, the braking performance of the tire 2 can be enhanced.

Each of the blocks 24, 26, 28 and 30 has a large number of small grooves G. When a wavy curve is assumed on the surface of the tread portion 4, the small groove G is formed along a portion included in the blocks 24, 26, 28 and 30 in the wavy curve. In other words, the shape of the small groove G is a part of the wavy curve. As is clear from FIG. 2, the wavy curve is extended in an axial direction. The wavy curve reaches an end Eb from the end Ea of the tread portion 4. A large number of wavy curves are assumed repetitively in a circumferential direction. A typical wavy curve is a sine curve. The small groove G may have another shape.

The small groove G has an edge. Consequently, a coefficient of friction of a road surface and the tire 2 can be enhanced by the small groove G. The small groove G also contributes to a dewatering function. Furthermore, the small groove G also contributes to an air vent in the vulcanization of the tire 2.

The blocks 24, 26, 28 and 30 comprise a crosslinked rubber. Preferably, a short fiber is blended with a rubber composition to be used in the blocks 24, 26, 28 and 30. The short fiber is dispersed into the blocks 24, 26, 28 and 30. The short fiber scratches snowy and icy road surfaces. The short fiber contributes to the braking performance of the tire 2. The surfaces of the blocks 24, 26, 28 and 30 abut on a cavity face of the mold. Therefore, a skin layer is formed. The skin layer rarely contains the short fiber. In the tire 2 in a brand-new stage, the short fiber is not exposed on the surfaces of the blocks 24, 26, 28 and 30. At the start of the use of the tire 2, the siping S and the small groove G mainly contribute to the braking performance. With the use of the tire 2, the surfaces of the blocks 24, 26, 28 and 30 are gradually worn out. By the wear-out, the small groove G becomes gradually shallower so that the short fiber is gradually exposed. When the wear-out progresses, the short fiber contributes to the braking performance in place of the small groove G. In the tire 2, an excellent braking performance can be exhibited over a long period from the start of the use.

The short fiber to be blended may be an inorganic fiber or an organic fiber. Specific examples of the inorganic fiber include a glass fiber and a carbon fiber. Specific examples of the organic fiber include a nylon fiber, a polyester fiber and a polyethylene fiber. Plural kinds of fibers may be used together. In the light of the braking performance, the glass fiber is preferable. The glass fiber and other fibers may be used together. The diameter of the short fiber is preferably 1 μm or greater and 100 μm or less. The length of the short fiber is preferably 0.1 mm or greater and 5.0 mm or less. The amount of the short fiber is 1 part by weight or greater and 50 parts by weight or less with respect to 100 parts by weight of a base rubber.

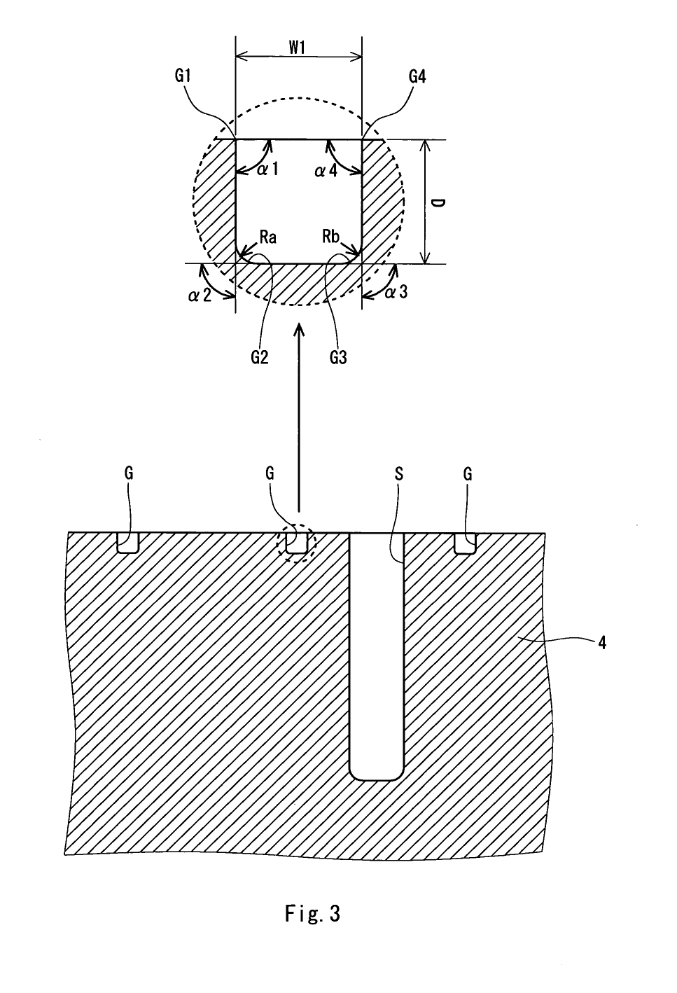

FIG. 3 is a sectional view showing a part of the tread portion 4 of the tire 2 in FIG. 1. In FIG. 3, the siping S and the small grooves G are shown. As is clear from an enlarged view which is shown in a big circle in FIG. 3, the shape of cross section of the small groove G is almost rectangular. The small groove G has a first corner G1, a second corner G2, a third corner G3 and a fourth corner G4. The corners G2 and G3 at the bottom of the small groove are rounded. In FIG. 3, what is indicated by an arrowhead Ra is a curvature radius of the second corner G2 and what is indicated by an arrowhead Rb is a curvature radius of the third corner G3.

What is indicated by a both-sided arrowhead W1 is a width of the small groove G. The width W1 is preferably 0.1 mm or greater and 2.0 mm or less. The small groove G having a width of equal to or greater than 0.1 mm is excellent in a dewatering function. In this respect, the width W1 is more preferably equal to or greater than 0.3 mm. By setting the width W1 to be equal to or less than 2.0 mm, a sufficient contact area is obtained. By the sufficient contact area, an excellent braking performance is obtained. In this respect, the width W1 is more preferably equal to or less than 0.6 mm.

What is indicated by a both-sided arrowhead D in FIG. 3 is a depth of the small groove G. The depth D is preferably 0.1 mm or greater and 1.0 mm or less. The small groove G having a depth of equal to or greater than 0.1 mm is excellent in a dewatering function. In this respect, the depth is more preferably equal to or greater than 0.4 mm, and particularly preferably equal to or greater than 0.5 mm. By setting the depth D to be equal to or less than 1.0 mm, sufficient block rigidity is obtained. By the great rigidity, deformation of the blocks 24, 26, 28 and 30 is restrained and a sufficient dewatering function is obtained. In this respect, the depth D is more preferably equal to or less than 0.6 mm.

A pitch of the small grooves G is preferably 0.5 mm or greater and 5.0 mm or less. By setting the pitch to be equal to or greater than 0.5 mm, sufficient block rigidity is obtained. By the great rigidity, deformation of the blocks 24, 26, 28 and 30 is restrained and a sufficient dewatering function is obtained. In this respect, the pitch is more preferably equal to or greater than 1.0 mm. By setting the pitch to be equal to or less than 5.0 mm, a sufficient braking performance is obtained. In this respect, the pitch is more preferably equal to or less than 4.5 mm. The pitch is measured along a perpendicular direction to the direction of the extension of the wavy curve. On the tire in FIG. 2, the pitch is measured along a circumferential direction.

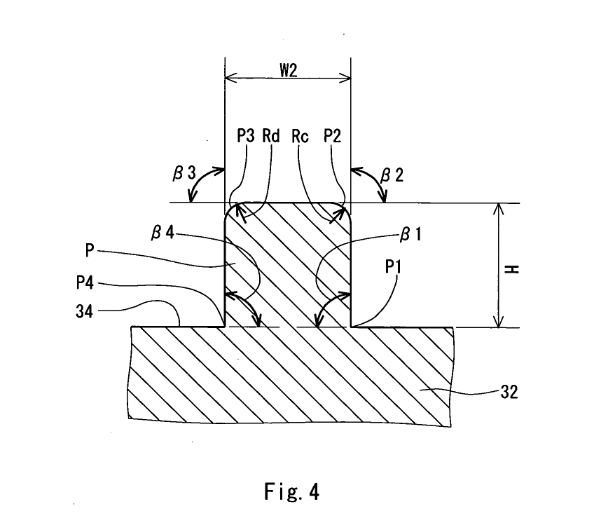

FIG. 4 is a sectional view showing a part of a mold 32 used at a step of vulcanization of the tire 2 in FIG. 1. In this FIG. 4, a cavity face 34 which abuts on the tread portion 4 is shown. The cavity face 34 has a protruding ridge P. As is clear from FIG. 4, the shape of cross section of the ridge P is almost rectangular. The ridge P has a first corner P1, a second corner P2, a third corner P3 and a fourth corner P4. The ridge P can be formed by cutting a master by a flat end mill. This ridge P corresponds to the small groove G of the tire 2.

This mold 32 is mounted to a vulcanizer. As the mold 32 repeatedly used to vulcanize the tire 2, sediment is generated on the cavity face 34. The mold 32 with the sediment is detached from the vulcanizer and given a shot blasting treatment. By the shot blasting treatment, the sediment is removed. This process is called a cleaning. After the cleaning, the mold 32 is fixed to the vulcanizer to use again. As the mold 32 is repeatedly used and received cleaning, the cavity face 34 is ground because of the effect of the shot blasting treatment. By the grinding, the ridge P is gradually worn out. As mentioned above, the shape of cross section of this ridge P is almost rectangular. Consequently, the appropriate shape of cross section is maintained even if the ridge P is worn out a little. This mold 32 can produce the tire 2 having the small grooves G with favorable shape even if the mold is worn out a little. This mold 32 has a longer life duration compared to the conventional mold having ridge with a shape of cross section of trapezium or triangle and the like.

In the light of the life duration of the mold 32, included angles β1, β2, β3 and β4 of the ridge P are preferably 80° or greater and 100° or less, and more preferably 85° or greater and 95° or less. Ideally, the included angles β1, β2, β3 and β4 are right angles (i.e. 90°). In the present application, the shape of cross section of the ridge P is called “almost rectangular” including the cases when the included angles β1, β2, β3 and β4 have a little different angles from a right angle. As is clear from FIG. 4, each of the corners P1, P2, P3 and P4 are assumed that they are not rounded when measuring the included angles β1, β2, β3 and β4.

The tire 2 has a reversed shape of the mold 32. The shape of the small groove G (see FIG. 3) depends on the shape of the protruding ridge P. An angle α1 of the groove G corresponds to the included angle β1 of the ridge P, an angle α2 of the groove G corresponds to the included angle β2 of the ridge P, an angle α3 of the groove G corresponds to the included angle β3 of the ridge P and an angle α4 of the groove G corresponds to the included angle β4 of the ridge P. The angles α1, α2, α3 and α4 are preferably 80° or greater and 100° or less, and more preferably 85° or greater and 95° or less. Ideally, the angles α1, α2, α3 and α4 are right angles. In the present application, the shape of cross section of the small groove G is called “almost rectangular” including the cases that the angles α1, α2, α3 and α4 have a little different angles from a right angle. As is clear from FIG. 3, each of the corners G1, G2, G3 and G4 are assumed that they are not rounded when measuring the included angles α1, α2, α3 and α4.

As is clear from FIG. 4, the corners P2 and P3 on the top surface are rounded. In FIG. 4, what is indicated by an arrowhead Rc is a curvature radius of the second corner P2 and what is indicated by an arrowhead Rd is a curvature radius of the third corner P3. The rounded corners are formed owing to circumstances when the mold 32 is produced. In the light of that the appropriate shape of the ridge P is maintained even when the ridge P is worn by the shot blasting treatment, the smaller the curvature radii Rc and Rd are preferable. Specifically, the curvature radii Rc and Rd are preferably equal to or less than 0.2 mm, and more preferably equal to or less than 0.1 mm. Ideally, the corners are not rounded. The first corner P1 and the fourth corner P4 may be rounded. In this instance, the curvature radii of the first corner P1 and the fourth corner P4 are preferably equal to or less than 0.2 mm, and more preferably equal to or less than 0.1 mm. In the present application, the shape of cross section of the ridge P is called “almost rectangular” including the cases that each of the corners P1, P2, P3 and P4 are rounded a little.

As mentioned above, the shape of the small groove G (see FIG. 3) depends on the shape of the protruding ridge P. The second corner G2 of the small groove G corresponds to the second corner P2 of the ridge P and the third corner G3 of the small groove G corresponds to the third corner P3 of the ridge P. The curvature radius Ra of the second corner G2 and the curvature radius Rb of the third corner G3 of the small groove G are preferably equal to or less than 0.2 mm, and more preferably equal to or less than 0.1 mm. Ideally, the corners are not rounded. The first corner G1 and the fourth corner G4 may be rounded. In this instance, the curvature radii of the first corner G1 and the fourth corner G4 are preferably equal to or less than 0.2 mm, and more preferably equal to or less than 0.1 mm. In the present application, the shape of cross section of the small groove G is called “almost rectangular” including the cases that each of the corners G1, G2, G3 and G4 are rounded a little.

What is indicated by a both-sided arrowhead H in FIG. 4 is a height of the ridge P. This height H substantially coincides with the depth D which is shown in FIG. 3. The height H is preferably 0.1 mm or greater and 1.0 mm or less. By setting the height H to be equal to or greater than 0.1 mm, the appropriate shape of the ridge P is maintained even when the ridge P is worn by the shot blasting treatment. In this respect, the height H is preferably equal to or greater than 0.3 mm, more preferably equal to or greater than 0.4 mm, and particularly preferably equal to or greater than 0.5 mm. By setting the height H to be equal to or less than 1.0 mm, sufficient block rigidity is obtained. By the great rigidity, deformation of the blocks 24, 26, 28 and 30 is restrained and a sufficient dewatering function is obtained. In this respect, the height H is more preferably equal to or less than 0.6 mm.

What is indicated by a both-sided arrowhead W2 in FIG. 4 is a width of the ridge P. This width W2 substantially coincides with the width W1 of the small groove G which is shown in FIG. 3. The width W2 is preferably 0.1 mm or greater and 2.0 mm or less. By this range of the width W2, the small groove G with an appropriate width W1 is formed. The width W2 is more preferably equal to or greater than 0.3 mm. The width W2 is more preferably equal to or less than 0.6 mm.

On a tire having a plural vertical grooves and a plural ribs partitioned by these vertical grooves, the braking performance is improved by forming the small grooves G on the surface of the tread portion. In this instance, it is preferable that the shape of cross section of the small groove G is also substantially rectangular. This small groove G has a width of 0.1 mm or greater and 2.0 mm or less and a depth of 0.1 mm or greater and 1.0 mm or less.

### EXAMPLES

### Example 1

A mold whose shape of cross section is rectangular, and having ridges with a width W2 of 0.4 mm and a height H of 0.5 mm was produced. Curvature radii Rc and Rd of the ridge were 0.1 mm. The shape of the tire which is obtained by this mold is shown in FIG. 1 and FIG. 2.

### Example 2

A mold was obtained in the same manner as in Example 1 except that the height of the ridge was set to be 0.3 mm.

### Comparative Example 1

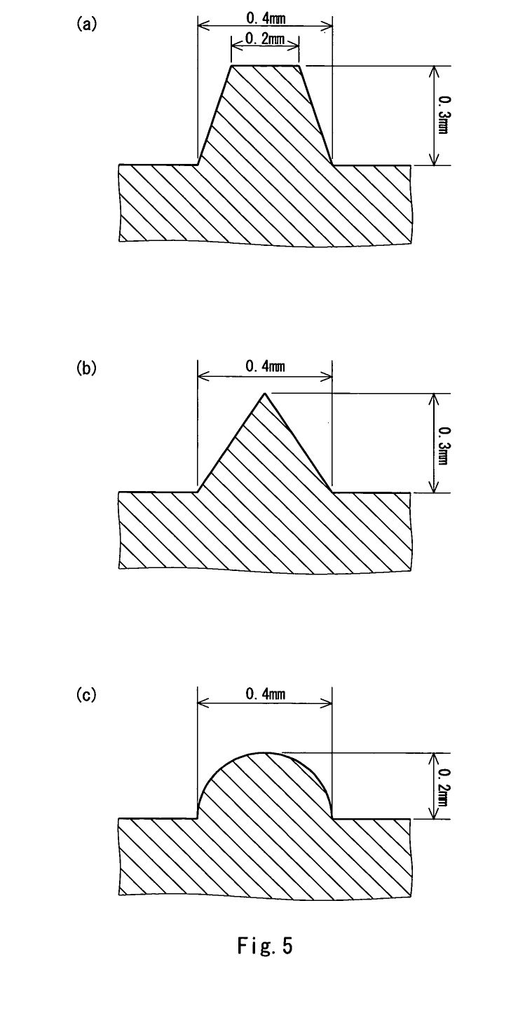

A mold was obtained in the same manner as in Example 1 except that the height of the ridge was set to be 0.3 mm and the shape of cross section of the ridge was set to be a trapezium as shown in FIG. 5 (a).

### Comparative Example 2

A mold was obtained in the same manner as in Example 1 except that the height of the ridge was set to be 0.3 mm and the shape of cross section of the ridge was set to be a triangle as shown in FIG. 5 (b).

### Comparative Example 3

A mold was obtained in the same manner as in Example 1 except that the height of the ridge was set to be 0.2 mm and the shape of cross section of the ridge was set to be a semicircle as shown in FIG. 5 (c).

[Measurement of Residual Height]

A mold was given a shot blasting treatment for 30 minutes. And then, a residual height of a ridge of the mold was measured. The result of the measurement is shown in the following Table 1.

[Evaluation of Appearance]

A tire was produced with the mold which was given a shot blasting treatment as mentioned above. The surface of the tread portion of the tire was visually observed and graded according to the following standard.

A: The appearance of the small groove is sharp.

B: The appearance of the small groove is a little indistinct.

C: The appearance of the small groove is indistinct. The result of the evaluation is shown in the following Table 1.

TABLE 1
Result of Evaluation

| | | | Comparative | Comparative | Comparative |
|---|---|---|---|---|---|
| | Example 1 | Example 2 | Example 1 | Example 2 | Example 3 |
| Shape of cross | Rectangle | Rectangle | Trapezium | Triangle | Semicircle |
| section | | | | | |
| Width W2 (mm) | 0.4 | 0.4 | 0.4 | 0.4 | 0.4 |
| Height H (mm) | 0.5 | 0.3 | 0.3 | 0.3 | 0.2 |
| Residual height | 0.36 | 0.15 | 0.10 | 0.07 | 0.07 |
| (mm) | | | | | |
| Appearance | A | B | C | C | C |

As is clear from Table 1, the tires which were obtained from the mold according to each of the examples have favorable small grooves. From the result of the evaluation, the advantages of the present invention are apparent.

The above description is only illustrative and various changes can be made without departing from the scope of the present invention. The tread pattern described above can be applied to various vehicle tires in addition to a studless tire.

What is claimed is:

1. A pneumatic tire having a tread portion,
wherein a large number of small grooves with a width of 0.1 mm or greater and 2.0 mm or less and a depth of 0.1 mm or greater and 1.0 mm or less are formed on the surface of the tread portion, and
the shape of cross section of the small groove is almost rectangular.

2. The pneumatic tire according to claim 1, wherein curvature radius of the corner at the bottom of the small groove is equal to or less than 0.2 mm.

3. The pneumatic tire according to claim 1, wherein said tread portion is formed by crosslinking a rubber composition having a short fiber dispersed therein.

4. The pneumatic tire according to claim 1,
wherein said tread portion has a vertical groove, a lateral groove and a large number of blocks partitioned by the vertical groove and the lateral groove, and
said small grooves are formed on the surface of the blocks.

5. A mold for a tire wherein,
a large number of ridges with a width of 0.1 mm or greater and 2.0 mm or less and a height of 0.1 mm or greater and 1.0 mm or less are formed on a cavity face which abuts on a tread portion of a tire, and
the shape of cross section of the ridge is almost rectangular.

6. The mold according to claim 5, wherein curvature radius of the corner of top surface of the ridge is equal to or less than 0.2 mm.
